(19) United States
(12) Patent Application Publication
(10) Pub. No.: US 2002/0184246 A1
(43) Pub. Date: Dec. 5, 2002

(54) Multidisciplinary project integration system

(76) Inventor: Shlomo Shkolnik, Tel-Aviv (IL)

Correspondence Address: William H Dippert, Cowan Liebowitz & Latman, 1133 Avenue of the Americas, New York, NY, 10036-6799, US

(21) Appl. No.: 09/914,487

(22) PCT Filed: Dec. 25, 2000
(86) PCT No.: PCT/IL00/00857

(51) Int. Cl. G06F 12/00

(52) U.S. Cl. 707/203

(57) ABSTRACT

A vehicle design database system which includes a plurality of records which describe major elements of a vehicle, the records describing substantially only major elements, at least one indication of the relative assembly of the major elements, a plurality of references to workers in charge of the major elements, and a plurality of references to documents related to the major elements.

### RELATED APPLICATIONS

The present application claims the benefit under 35 USC 119(e) of U.S. Provisional application No. 60/173,718 filed Dec. 30, 1999, the disclosure of which is incorporated herein by reference in its entirety.

### FIELD OF THE INVENTION

The present invention relates to the design of aircraft and particularly to methods for fast information flow in large design staffs.

### BACKGROUND OF THE INVENTION

Aircraft design is a very complex task which usually requires several years of work by thousands of engineers. Even a simple aircraft comprises many separate systems and subsystems, such as systems for avionics, communications, electricity and hydraulics. All of the systems must be integrated and confined within a given structure, without interfering with each other. Conventionally, however, each system is planned separately by different engineers using different design tools. The interaction between the different tools is a major problem in the aircraft planning industry. In addition, it is necessary to coordinate between project, design, manufacture and procurement engineers. For example, a design engineer may design an aircraft based on production methods which are non-existent or too expensive.

Each engineer usually plans the system on which he/she is in charge without relation to other systems of the aircraft. A department or project manager finds problems in the integration of the plans of all the engineers in the department and orders the engineers involved in each integration problem to resolve the problem. Usually, this process is repeated a few times for increasing levels of integration. This process is time consuming and wasteful.

It is customary in the aircraft industry to have workers from different departments, such as design, maintenance, procurement and production workers, work in adjacent rooms such that they can receive information from each other. However, this is usually helpful only for general information and not for specific details of a project, since the details of the project are generally distributed between thousands of workers.

Product Data Management (PDM) systems are used to bridge the information gap between design and manufacturing during the release and configuration management phase of a product development process. In a PDM system, a product is described using an item tree which depicts the structure of the product. The PDM system stores, for each item, documents relating to the item. In order to find a document relating to an item, a worker searches down the item tree to the desired item. In the tree, the elements of each system are located on different branches of the tree. Some PDM systems are integrated with enterprise resource planning (ERP) systems. Usually implementing the use of a PDM system within an organization requires drastically changing the work patterns of all of the workers in the organization.

Some CAD tools, described for example in “CAD software integration”, Aerospace Engineering, March 1999, the disclosure of which is incorporated herein by reference, are directed to integrated product development. For example, an article in “Aviation Week & Space Technology” from Jun. 3, 1991, describes a computerized design system for airplanes. The system, named Computer Aided Three-dimensional Interactive Application (CATIA), stores all the plans of an airplane in a single system allowing substantially concurrent access to the plans to engineers from different departments. Each part is tagged in the computer file with the name and telephone number of the person responsible for the part. Thus, when an engineer wishes to perform changes to the plans he/she may easily determine who to talk to.

The PDM and CATIA systems, however, are very sophisticated and costly, and include enormous amounts of information which may “flood” the user. The use of each of these systems generally requires lengthy training of the workers. Usually, each user relates only to that part of the database which relates to the user's department. Furthermore, in many cases workers are not allowed to view information of other departments, in order to prevent free flow of confidential information. Even if the user receives permission to view information of other departments, he/she may not know where exactly to look. The CATIA system must be run on expensive work stations which can handle three dimension graphical data.

In many industries, a part number identifies substantially each item of a product. If the item appears in several locations, the same part number is assigned to the part in all the locations. The part numbers are commonly used to identify items on drawings and/or CAD programs. In the aircraft industry the part numbers usually have the following form: “xxxyyyzzzz”, in which xxx identifies the project, yyy is a three digit number assigned by Configuration Management to the various systems or parts of the product and zzzz designates a number of the product within the system identified by yyy. Sub-parts of an item are marked using the part number of the item with a suffix identifying the sub part.

Codes which identify elements according to their location and/or functionality, such that if the same element appears in several locations each element is given a different code, exist in some systems of aircrafts. For example, an interface standard referred to as MIL-W-5088, the disclosure of which is incorporated herein by reference, describes codes for wiring aerospace vehicles. The codes in this standard reflect the functions of the wires, their size and the unit in which the wires are included. These codes are usually imprinted on the wires, such that during production and/or maintenance it is easy to determine the purpose of a specific wire.

In many companies project management is performed using a Work Breakdown Structure (WBS) which defines a product being developed. A responsibility assignment matrix is used to state who performs each task in the WBS. The RAM and WBS are described, for example, in http://nnh.com/ev/ available in November 1999, the disclosure of which is incorporated herein by reference.

### SUMMARY OF THE INVENTION

An aspect of some embodiments of the invention relates to an object oriented database which describes an aerospace vehicle. For each major element of the vehicle, the database includes information on the integration of the element within the vehicle and references to humans and documents related to the element. Thus, the database serves as an index to the planned vehicle. Optionally, the database includes mainly information which is of interest to several workers from different departments. Optionally, the database does not include drawings and diagrams which require large amounts of storage and are usually of little interest to workers not in the department in charge of the elements described by the drawings.

Optionally, the major elements included in the database are those elements which interact with other elements of the vehicle. Alternatively or additionally, the major elements are elements which appear on maps and/or wire diagrams of the vehicle. Further alternatively or additionally, the major elements are those elements which are handled by a plurality of personnel from different departments. The major elements generally do not include minor elements, such as bolts, nuts and rivets. Thus, the major elements usually account for less than ten percent, even less than one percent, of the elements in an aircraft.

In some embodiments of the present invention, the information on the integration of an element in the vehicle comprises the physical location of the element, the functionality of the element and/or the access paths to the element. Optionally, each record of an element references other elements which are related functionally or are located next to the element. In an embodiment of the present invention, the elements references are interconnected using hypertext links.

The references to documents optionally include references to all the drawings, documents, letters, route cards, etc., related to each major element. In some embodiments of the invention, the database includes links to the documents. When a user of the database actuates such a link, a different software carrying the document is opened so that the document may be viewed by the user. It is noted that the opening of the document depends on whether the user has authorization to view the document.

The references to humans in charge of an element are optionally stated by a job designation code which is in a format similar to element codes. Thus, when people change positions there is no need to change the references of a plurality of element records. Furthermore, the job designation code is optionally easily derived from the elements handled by the worker in the designated position.

Optionally, the database is of a small size which may fit on substantially any portable computer. Thus, a copy of the database may be taken, for example, to field tests and/or maintenance tasks. In addition, information from the database and even the entire database may be transferred within minutes over slow communication wires. Thus, a copy of the database may reside on a plurality of computers for the convenience of the workers.

In an embodiment of the present invention, the database does not include confidential material which should not be viewed by some of the workers within an organization. As the database serves as an index for workers who wish to receive information about issues not within their responsibility it is preferable that all the information be open to any worker.

An aspect of some embodiments of the present invention relates to running verification routines on a reduced size database which describes a complex project. In some embodiments of the present invention, the reduced size database does not include drawings. Alternatively or additionally, the database carries information substantially only on the major elements of the project. Verification routines for a reduced size database are simpler and run much faster than routines run on very large databases. Therefore, verification routines may be run more frequently according to project requirements on a reduced size database.

An aspect of some embodiments of the present invention relates to a method of marking elements on drawings, databases and/or on the elements themselves. The elements are marked using codes which relate to the functions and/or locations of the elements, and are selected in a single scheme for an entire vehicle. Thus, immediately upon reading the code, an engineer knows which element is identified by the code, and what is the purpose of the element. The identified elements may include parts, or assemblies of parts that are closely related. Alternatively or additionally, the identified parts comprise connectors of parts, such as wire connectors, and rod edges. Thus, a single element may carry several codes.

Optionally, the codes indicate the system and sub-system to which the elements belong, as well as numbers for identifying the element within the sub-system. Connections are optionally identified in addition according to the type of the connection.

There is therefore provided in accordance with some embodiments of the present invention, a vehicle design database system, including a plurality of records which relate substantially only to major elements of a designed vehicle, at least one indication of the relative assembly of the major elements, a plurality of references to workers in charge of the major elements, and a plurality of references to documents related to the major elements.

Optionally, the plurality of records include a record for each of the major elements of the aircraft, and the major elements include elements which interact with other elements of the vehicle. Optionally, the at least one indication of the relative assembly includes an indication in each record of the major elements which are functionally related to the element described by the record. Alternatively or additionally, the at least one indication of the relative assembly includes an indication in each record of the coordinates in the vehicles framework of the element described by the record. Optionally, the at least one indication of the relative assembly includes an indication for at least one of the major elements of an access door of the element and/or of a compartment in which the element is located. Optionally, the at least one indication of the relative assembly includes an indication in each record of the major elements with which the element interacts. Optionally, the database substantially does not include drawings. Further optionally, the database requires less than 1 Gbytes of storage space, more optionally less than 100 Mbytes of storage space. Optionally, the database includes records for less than 10% of the elements of the vehicle. Further optionally, the database includes records for less than 1% of the elements of the vehicle.

Optionally, the references to the documents include hypertext links. Optionally, the documents include diagrams including the elements and/or procurement invoices of the elements. Optionally, each of the elements is identified by a unique code which is assigned according to the functionality of the element. Optionally, the database is associated with at least one computerized tool such that an update of information in the at least one computerized tool automatically updates the database. Optionally, the database is accessible over a network which connects a plurality of remote processors. Alternatively or additionally, the database is stored on a portable computer. Optionally, the database includes input and output information of at least one data evaluation program molded into the form of the database. Optionally, the at least one data evaluation program includes a design to cost program and/or a design for manufacture and assembly program.

There is further provided in accordance with some embodiments of the present invention, a method of forming a vehicle design index, including automatically gathering from a plurality of computerized tools, information on substantially all the major elements of a vehicle, and storing the information in the index. Optionally, gathering the information includes gathering location and/or interconnection information of the major elements. Optionally, gathering the information includes gathering references to documents describing the major elements. Optionally, a company designing the vehicle includes at least one group of workers which are restricted from viewing information relating to the vehicle and gathering the information includes gathering information which is not restricted for viewing by substantially any of the workers of the company. Optionally, gathering the information includes gathering from tools which carry information restricted for viewing within the company designing the vehicle. Optionally, storing the information includes storing the information in a database.

In some embodiments of the invention, gathering the information includes gathering information on elements of an aircraft. Optionally, automatically gathering the information includes automatically gathering the information periodically.

There is further provided in accordance with some embodiments of the present invention, a method of providing information between workers designing a vehicle, including gathering, for each of a plurality of major elements of the vehicle, information regarding the element, including a plurality of different indications of the relative assembly of the element, and a plurality of references to workers in charge of the element, storing the gathered information in a database, and searching the database for data on one or more major elements. Optionally, gathering the information includes gathering references to documents related to the major elements. Optionally, the plurality of different indications of the relative assembly of the element include at least one indication of the location of the element. Optionally, the at least one indication of the location of the element includes an indication of the coordinates of the element within the vehicle. Alternatively or additionally, the at least one indication of the location of the clement includes an indication of an access door to the element within the vehicle. Further alternatively or additionally, the at least one indication of the location of the clement includes an indication of a compartment in which the element is located.

Optionally, the plurality of different indications of the relative assembly of the element include a list of the major elements with which the element is connected and/or an indication of a system to which the element belongs Optionally, the indication of the system to which the element belongs includes an indication of the relative function of the element within the system. Optionally, the method includes running a verification routine which finds design faults, on the database. Optionally, running the verification routine includes running a routine which checks for elements which are distanced from each other less than a minimal allowed distance. Optionally, storing the gathered information in the database includes storing the information in a database which does not include diagrams or drawings.

There is further provided in accordance with some embodiments of the present invention, an aircraft designed using any of the above described methods of distributing information.

There is further provided in accordance with some embodiments of the present invention, a method of labeling major elements of an aircraft, including determining for each major element the system to which the element belongs, and assigning each of the major elements with a code which is unique to each occurrence of the element, responsive to the system to which the element belongs. Optionally, the major elements include elements belonging to the structure of the aircraft. Optionally, assigning the code includes assigning a code having at least three digits in common with the digits of a part number of the element, for substantially all the major elements of the aircraft. Alternatively or additionally, assigning the code includes assigning a plurality of codes to at least one single element. Optionally, the plurality of codes assigned to a single element include codes which represent connections of the element.

There is further provided in accordance with some embodiments of the present invention, a method of referencing workers working on an aircraft, including assigning configuration management codes to various aspects of the aircraft, assigning each of the parts of the aircraft, a part number code which includes the assigned configuration management code of the aspect to which the part number belongs, and assigning worker codes which include the configuration management code of the aspect on which the worker works. Optionally, the configuration management codes include three digits. Optionally, the method includes preparing a responsibility matrix which references workers by the assigned worker codes.

### BRIEF DESCRIPTION OF THE DRAWINGS

The invention will be more clearly understood by reference to the following description of embodiments thereof in conjunction with the figures, wherein identical structures, elements or parts which appear in more than one figure are labeled with the same or similar numeral in all the figures in which they appear, in which:

FIG. 1 is a schematic block diagram of a working environment in an aircraft design company, in accordance with an embodiment of the present invention;

FIG. 2 is a flow chart of actions performed using an aircraft index database, in accordance with an embodiment of the present invention;

FIG. 3 is a schematic block diagram of the internal structure of an aircraft index database, in accordance with an embodiment of the present invention;

FIG. 4 is a schematic illustration of a uniform MRD code structure, in accordance with an embodiment of the present invention;

FIG. 5 is a flow chart of the actions performed by an engineer desiring to perform a change in the design of an aircraft, in accordance with an embodiment of the invention; and

FIG. 6 is a schematic illustration of a responsibility assignment matrix (RAM), in accordance with an embodiment of the present invention.

### DETAILED DESCRIPTION OF EMBODIMENTS

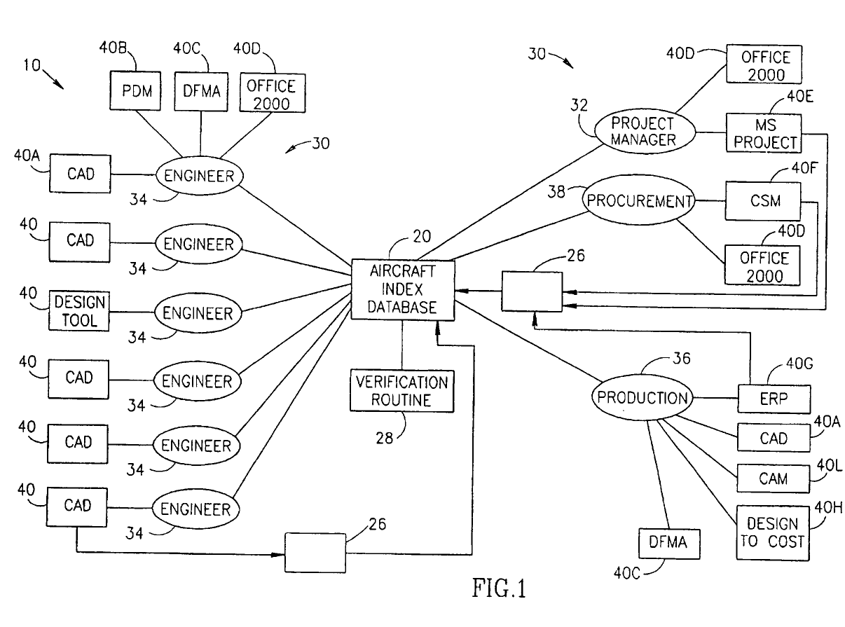

FIG. 1 is a schematic block diagram of a working environment 10 in an aircraft design company, in accordance with an embodiment of the invention. A plurality of workers (represented generally by 30), organized in a plurality of departments, design and/or manufacture different systems of an aircraft. Usually the number of workers 30 is of the order of thousands or more. Workers 30 optionally include engineers 34 of various tasks, such as engineers of specific systems (e.g., hydraulics, avionics, electricity), and integration engineers (e.g., safety regulations and simulations). Workers 30 optionally also include project engineers/managers 32, production personnel 36, procurement personnel 38, and/or other workers. Most of workers 30 optionally use computerized tools 40, such as CAD 40A and CAM 40L tools, word processors and other office tools 40D, project planning tools 40E, accounting tools, a product data management (PDM) system 40B, an enterprise resource planning (ERP) system 40G, and a components and supplier management (CSM) system 40F, which are fitted to specific tasks performed by the respective workers. The number of separate tools 40 may be of the order of hundreds and many of the tools require lengthy training of the workers 30 using them.

In some embodiments of the invention, a database 20 serves as an index to the aircraft being designed and/or manufactured in working environment 10. Database 20 is optionally of a small size allowing easy download and transfer of the database. In an embodiment of the invention, the database requires less than 100 Mbytes of data, or even less than 50 Mbytes. In an embodiment of the invention, database 20 comprises only text information and does not include drawings and maps which require large amounts of storage space. It is noted that the information included in drawings is usually highly technical and is usually not of interest to workers other than the worker in charge of the drawing.

Optionally, each of workers 30 has access to database 20 and may query the database for necessary information which is not related to the worker's department. In some embodiments of the invention, a plurality of copies of database 20 are available throughout environment 10 on a plurality of computers and updates are distributed periodically (e.g., hourly, daily, weekly). Alternatively, database 20 is located on a single server, and workers may access the database through a local area network, a dial-up link, and/or a wide area network.

Database 20 optionally comprises records for substantially all of the major elements of the designed aircraft. Database 20 describes the relations between the various elements and includes references to documents and workers related to the elements. The relations between the elements optionally include one or more of the functionalities of the elements, cross connections between elements and/or the locations of the elements. The functionalities of an element optionally include the systems and/or sub-systems to which the element belongs. The cross connections optionally refer for each element to the elements to which the element is connected, the sub-elements included in the element and/or an element in which the element is included. Optionally, the relations between the elements in database 20 are according to a plurality of different categorizations. It is noted that a prior art DPM system generally does not include cross connections and the data on each element in the DPM system is found in a specific position of a product tree.

In some embodiments of the invention, database 20 includes only general information about the designed aircraft, which information is not considered secret or restricted in viewing by substantially any of workers 30.

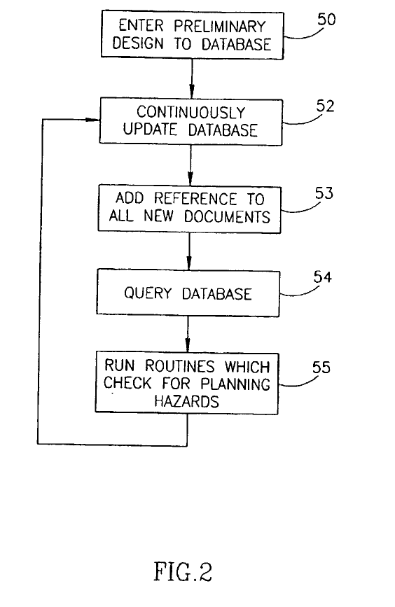

FIG. 2 is a flow chart of actions performed on database 20 in aiding the design of an aircraft, in accordance with an embodiment of the invention. During an early stage of design, in which a project definition, an engineering preliminary design and a production technology are formulated, the information on the structure of the aircraft is entered (50) into database 20. Optionally, each design engineer 34 enters the structure information to which he/she is responsible. In some embodiments of the invention, other information is entered by workers 30 for which they are responsible. Alternatively, during the early design, the information is entered centrally by a single department. In some embodiments of the invention, some or all of the information is entered automatically from CAD/CAM planning tools (40A, 40L) and/or from other design tools 40, for example, using routines for data extraction from the tools 40 to database 20.

Optionally, during the preliminary design a project manager initiates rules which determine which elements are considered major elements for the specific project and which elements are considered minor elements. According to these rules the information on the major elements is entered to the database. At a later time, minor elements which turn into major elements may optionally be entered into the database. Similarly, elements may be removed from the database if they are altogether unnecessary or if they become minor elements.

Thereafter, workers 30 continuously update (52) the information in database 20 with respect to changes in the relationship between the major elements. In some embodiments of the present invention, automatic routines 26 which extract information from tools 40 and place it in database 20, are run periodically on some are all of computerized tools 40.

In addition, for each new document which relates to one or more major elements of the aircraft, references which direct interested workers 30 to the document are optionally added (53) to database 20. For example, in some embodiments of the invention, a word processor used in preparing documents asks users to list the elements to which the document relates. An automatic agent adds a reference to the new document to the records in database 20 of the listed elements.

In some embodiments of the invention, some of the information in the referenced documents is entered to database 20. Optionally, the entered information is information which is commonly used and/or is information which interests workers other than those directly working on the element to which the information pertains. Alternatively or additionally, the entered information comprises information which is used by verification routines 28 run on database 20 to determine planning hazards.

During later stages of planning, when a worker 30 is interested in information from other departments, the engineer may receive the information or initial information about where to look and who to go to, by querying (54) database 20. Optionally, substantially all the information is open for viewing by all of workers 30. On the other hand, changes to the database optionally require specific authorization which is given to those workers responsible for the data being changed.

Optionally, one or more verification routines 28 are periodically run on database 20, to check (55) for planning hazards. Alternatively or additionally, verification routines 28 are run responsive of changes of at least a predetermined extent to database 20. The hazards may include, for example, having less than a minimal critical distance between elements which may interfere with each other, having unbalanced weight of the aircraft and/or exceeding a monetary budget of the aircraft. Verification routines 28 optionally further include routines which determine the feasibility of the aircraft design for production, procurement and/or maintenance. For example, a verification routine optionally reviews each access door of the aircraft verifying that accessing all of the elements listed as being accessed through the access door is feasible.

Alternatively or additionally, the information in database 20 is exported to an external standard program which performs verification and analysis tasks, such as design-to-cost 40H and design for manufacture and assembly (DFMA) programs 40C. In some embodiments of the invention, the results from the external standard program are returned to database 20 and are placed in the database in a structural form of the database. Optionally, the results from external programs which provide estimated data are compared at later times to actual data accumulated by database 20. For example, a routine running on database 20 optionally compares the results from a design-to-cost program to actual costs entered at a later time to the database.

It is noted that finding hazards by a computerized routine does not require drawings of the elements, and is much simpler without the drawings. Location information, as described hereinbelow, is usually sufficient for identifying potential planning hazards. In some embodiments of the invention, one or more of the verification routines point out potential hazards, and a human worker determines whether the hazard is an actual hazard. Alternatively or additionally, an artificial intelligence program is run on database 20 searching for potential hazards.

Thus, the use of database 20 begins at early design stages of the aircraft and continues until post production stages, optionally including maintenance at a client purchasing the aircraft. At early design stages, database 20 simplifies the communication between workers from different departments, allowing real time feedback on the integration of different systems being deigned. Optionally, the design of each system (e.g. hydraulic, electric) is continuously entered to database 20 allowing workers designing other systems to relate to the design of the system before changes become expensive and problematic.

Concurrently, and at more progressive design stages, database 20 serves as a communication tool between workers of different tasks, e.g., design engineers, project managers, and procurement and production personnel.

Sales engineers optionally also use database 20 in determining whether the aircraft fits the desires of the clients and/or to enter client requests. Such client requests are entered in the description of the system to which they relate such that the requests reach the relevant workers immediately. It is noted that database 20 is especially suited for loading onto portable computers which serve sales engineers, due to the small size of the database.

During maintenance of existing aircrafts, database 20 is optionally used by maintenance personnel to better understand the relationships between the elements of the aircraft. In some embodiments of the present invention, database 20 is available on a wide area network, such as the Internet. Maintenance personnel from various airline companies can use an on-line version of database 20 to receive information on various elements. In some embodiments of the present invention, the on-line version of database 20 serves as a discussion group through which maintenance workers from various companies exchange information.

Optionally, the precise data included in database 20 depends on the stage of the project described by the database. For example, the on-line version of database 20 which may be viewed by workers outside of an aircraft design company managing database 20, may include less information than a version which may be viewed only by workers of the aircraft design company.

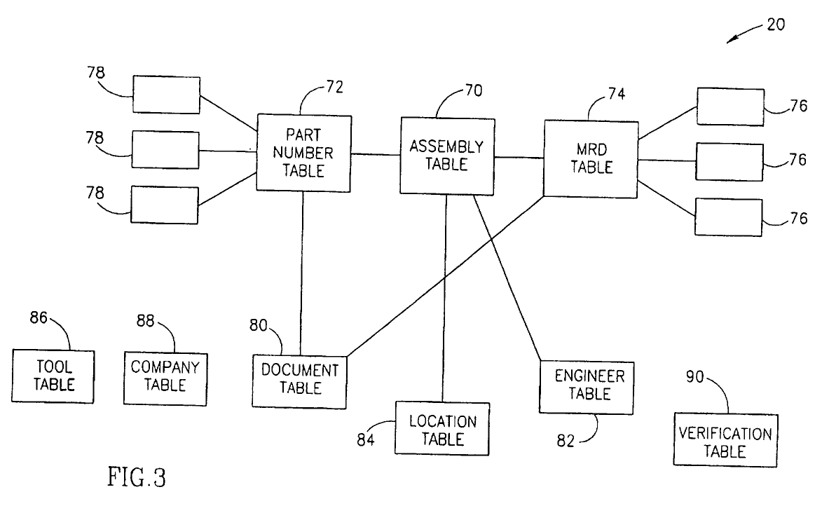

FIG. 3 is a schematic block diagram of the internal structure of database 20, in accordance with an embodiment of the present invention. Database 20 comprises an assembly table 70 which describes the relationship between the major elements of the designed aircrafts of the project. Assembly table 70 optionally lists for each major element of the designed aircraft, a map reference designator (MRD) code, a part number of the element, a location of the element and references to workers 30 responsible for various aspects of the element.

In some embodiments of the invention, database 20 is used to describe a plurality of aircrafts, with minor variations, belonging to a single project. Each record describing an element in assembly table 70 is optionally associated with a field which states the numbers of the aircrafts to which the record relates.

The MRD code optionally identifies the elements according to their functionality and/or their interconnection in the aircraft. Alternatively or additionally, the MRD code is related to the location of the element in the aircraft. It is noted that if the same element appears in several locations, each element is given a different MRD code, although the elements have the same part number. The term major element refers herein to any major assembly, part, or structure which is important enough to be included in database 20. Such major elements are optionally elements which interact with other elements of the aircraft. Alternatively or additionally, the major elements are elements which appear on assembly maps and/or wire diagrams. Further alternatively or additionally, the major elements are those elements which arc handled by a plurality of personnel from different departments.

The location of each element is optionally stated in a three-dimensional coordinate system of the aircraft. Optionally, the coordinates of the element are the coordinates of the center of mass of the element. Alternatively or additionally, the coordinates are of an envelope encompassing the element. In some embodiments of the invention, the coordinates of each element are stated in more than one coordinate system of the aircraft. In some embodiments of the invention, the location information also states the compartment of the aircraft in which the element is located according to any predetermined compartment division, such as the ATA 100 regulation division. Optionally, assembly table 70 also states the access door (bay) for maintenance of each element, for example using the ATA 100 standard. Alternatively or additionally, the compartment and/or the access door of the elements are considered related to the functionality of the element and are stated in MRD table 74 described hereinbelow or in one or more of its related tables 76.

Optionally, the listing of workers 30 responsible for the elements includes a supervisor of the element, a project engineer and/or manager of the element and a subcontractor related to the element. Alternatively or additionally, the worker listing includes all the engineers related to the element including, for example, engineers responsible for design, for critical parts, for weight and balance, for ground and flight tests, for production, for tools, and/or for procurement. In some embodiments of the present invention, database 20 shows the hierarchy of the workers related to the element.

In some embodiments of the invention, the engineers arc identified in database 20 according to their job descriptions. In some embodiments of the invention, each responsibility task of an engineer is assigned an engineer code which is used in table 70, and optionally throughout database 20, to identify engineers related to elements. It is noted, that a single engineer may perform several tasks and is therefore assigned several engineer codes. Alternatively or additionally, a single engineer code may refer to several engineers who perform the task together.

Optionally, a table 82 in database 20 associates the engineer codes with information relating to the engineers, such as employee ID, telephone number, address, department, etc. If the engineer in charge of a specific task is replaced during a project only a single record in table 82 needs to be replaced.

Optionally, a standard code scheme is used in assigning the codes. In an embodiment of the invention, engineer codes of workers in the same department and/or workers and their managers have similar codes. The engineer codes are optionally formulated using common elements with the part numbers and/or the MRD codes. Thus, the code of an engineer is closely related to the part numbers and/or MRD codes of the elements for which he/she is responsible. In an embodiment of the invention, the engineer code comprises the three digits of configuration management together with one or more additional letters and/or digits.

An MRD table 74 optionally states for each element, based on the MRD code, references to information relating to the element. The references optionally relate to the functionality of the elements and/or the interconnections of the elements within the aircraft. In some embodiments of the invention, MRD table 74 states for each element, the sub-elements included in the element, the parent element to which the element belongs, and/or the elements with which the element interconnects. Alternatively or additionally, MRD table 74 states for each element, the functionality of the element including an indication of the system to which the element belongs. Optionally, the system indication is stated in a nested form of system, sub-system and the sub-systems of the sub-systems. In some embodiments of the invention, each element is identified by at least three levels of system, sub-system and sub-sub-system.

In some embodiments of the invention, MRD table 74 includes references to one or more documents that describe the element and/or to additional tables 76 of database 20 which carry information related to the element.

In a manner similar to MRD table 74, a part number table 72 states references to information which depends on the part number of the element, i.e., are not related to the location of the element within the aircraft. As with MRD table 74, the references optionally relate to documents describing the element and/or additional tables 78 of database 20 which carry information related to the element. Optionally, part number table 72 is organized in a manner similar to part number tables known in the art.

In some embodiments of the invention, the document references state the locations of the documents in a manner which allows easy retrieval of the documents. In some embodiments of the invention, database 20 comprises a table 80 which lists for each document the location of the document as well as other information, such as the versions and sizes of the documents. The documents may be of any type known in the art, including reports (e.g., flight and ground test reports, technical reports), route cards (e.g., production route cards), action item lists, procurement invoices, advanced material orders, design criteria documents, federal aviation regulations, drawings, system maps, and/or wire diagrams. The documents listed in table 80 optionally comprise both paper and computer stored documents.

In some embodiments of the invention, the references to computerized documents include links to the documents. Optionally, actuating the link causes the document to be displayed on a computer screen before the user. Optionally, actuating the link opens the document using a software with which the document is associated.

In some embodiments of the invention, tables 76 list for each element, based on the MRD code, information regarding properties of the clement which are related to the relationship between the element and other elements. Such properties optionally include the grounding of the element, an action item list of the element, penetration information of the element (e.g., locations of holes in the element for pipes or tooling), aviation regulations pertaining to the element, design criteria related to the element, an advanced material order related to the element, failure listings of the element, environmental conditions of the element (e.g., surrounding temperature and pressure), a line replacement unit (LRU) of the element, and/or critical parts of the element.

Optionally, a table 76 includes for each element an action item list for the element. The action item list includes listings of actions related to the element which need to be performed and/or which were performed. The action item list can serve as an easy tool for passing messages related to an element between all the workers 30 who deal with the element.

In addition, the action item list can serve as an on line documentation of the history of the element, which list can be used by a worker beginning to work on the element to quickly determine what has been done with the element. Including the action item lists within database 20 which includes cross references to substantially all the major elements of the designed aircraft allows quick finding of the action item list and easy reference to information other elements related to actions listed in the list.

In some embodiments of the invention, tables 78 list for each element, properties of the structure of the element which are not related to the relationship of the element with other elements. Tables 78 are optionally organized using the part numbers of the elements. The properties listed in tables 78 optionally include the size and weight (target and/or actual) of the element, the material composition of the element, its natural vibration frequencies and/or its dynamics. Alternatively or additionally, tables 78 include a production technology of the element, references to tools and jigs used in producing the element, and/or other production or procurement information related to the element.

Optionally, the information in tables 76 and 78 is also available in the documents referenced by database 20 in relation to the element. Optionally, as described above, the information included in tables 76 and 78 is chosen based on the frequency of use of the information, and the amount of workers needing the information. Optionally, the amount of information included in tables 76 and 78 is not too large which may make database 20 cumbersome. In addition, tables 76 and 78 optionally do not include information which has restricted viewing.

Database 20 optionally includes other tables which elaborate on information in tables 70, 72, 74, 76 and 78. In some embodiments of the invention, database 20 comprises a location table 84 which provides details on the compartments and doors used in describing the locations of the elements. A tool table 86 optionally describes information related to tools used in design and manufacture of the aircraft A company table 88 optionally provides details on suppliers, manufacturers and/or other companies with which workers 30 are in contact.

In some embodiments of the invention, database 20 comprises one or more verification tables 90 which are used by verification routines 28 in determining hazards in the aircraft design. Verification tables 90 optionally include a table which lists the minimal required distances between different types of elements (e.g., moving elements, elements which generate magnetic fields).

In some embodiments of the invention, one or more of the above described tables are separated to a plurality of tables, for convenience of the internal structure of database 20. Alternatively or additionally, a plurality of the above described tables are combined into a single table.

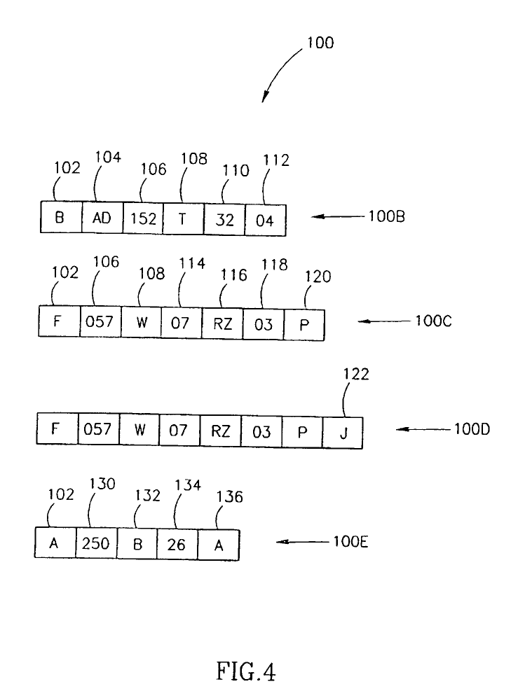

FIG. 4 is a schematic illustration of a uniform MRD code structure 100, in accordance to with an embodiment of the invention. Code structure 100 is optionally a global structure which covers all the major elements of an aircraft using a uniform set of rules. In some embodiments of the invention, code structure 100 is based on known coding schemes from the aircraft industry. For example, symbols used in part numbers and/or in wire labeling are optionally used in code structure 100. It is noted that workers 30 from different countries are sued to different symbols. Therefore, different code structures are optionally used by different companies. For example, American and European companies use different methods to designate the various sections of an aircraft. Therefore, in an embodiment of the invention, the codes used by Americans may be different than codes use by Europeans. In some embodiments of the invention, database 20 includes one or more translation tables for translating codes from different code structures. In an embodiment of the present invention, a worker 30 connecting to database 20 selects a code structure with which he/she is familiar and database 20 automatically displays all codes in the selected code structure.

In some embodiments of the invention, code 100 includes a letter 102 which designates the primary system to which the identified element belongs. Table 1 shows an exemplary assignment of letters to the primary systems of an aircraft. The letters in table 1, are shown by way of example, and substantially any other letter designation may be used. In particular, letters 102 are optionally designated based on conventions used in the aircraft industry and/or of the user of database 20.

TABLE 1

| System | code | system | code | system | code |
|---|---|---|---|---|---|
| Airstructure | A | Flight control | C | Fuel | F |
| Landing gear | G | Hydraulic | H | Electrical | L |
| Power generating | P | Avionics | R | ECS | V |

A group of letters 104 following letter 102 identifies the sub-system to which the element belongs. In some embodiments of the invention, the group of letters 104 comprises two letters which stand for the sub-system. Optionally, each system as identified by letter 102 has a separate list of possible letter groups 104 which correspond to the system. Alternatively or additionally, a three digit number 106 designates the sub-system or sub-sub-system to which the element belongs. Optionally, the three digit number 106 is identical to the numbers used in part numbers according to the configuration management. Elements which are wires or tubes are then marked respectively with the letters W and T 108. Thereafter, the code optionally states parameters of the wire or tube. In some embodiments of the invention, in tubes, as illustrated by code structure 100B, the parameters comprise a two digit tube number 110 and a two digit tube size indication 112. For wires, as illustrated by code structure 100C, the parameters optionally comprise a two digit wire number 114, two letters indicating a wire segment 116, two digits which indicate a wire size 118 and a letter 120 which indicates whether the wire leads phase (P), ground (G) or thermocouple (T).

In some embodiments of the invention, in elements which have connections, as illustrated by code structure 100D which is a connector of the wire described by code structure 100C, the connections are given codes separate from the element itself. The connection codes optionally comprise the code of the element with an additional letter 122 indicating the type of the connection. Optionally, electrical connectors are indicated by a ‘J’ suffix, electrical plugs are indicated by a ‘P’ suffix, fluid inlets or outlets are indicated by an ‘X’ suffix and reciprocal fluid connectors are indicated by a ‘Y’ suffix. Thus, each wire and/or tube has several MRD codes. The entire wire or tube has a code, and each connection end of the wire or code has a separate code. Optionally, database 20 lists the other connections to which each connection end is connected.

In an embodiment of the invention, structure elements are indicated (as illustrated by code structure 100E) by a letter A 102, and are followed by three digits 130 which indicate the section of the aircraft in which the structure element is located. In some embodiments of the invention, digits 130 are determined based on a standard division of aircrafts, such as the configuration management three-digits regularly used in part numbers. Digits 130 are optionally followed by a single letter 132 which designates the type of the structure element, e.g., B-beam, L-longeron, H-hinge, S-skin, etc. Letter 132 is optionally followed by two digits 134 which represent a skin number of the element.

In an embodiment of the invention, elements which are assemblies, i.e., include other major elements, have a suffix “A” 136. Optionally, assembly table 70 lists the MRD codes of the elements included in each assembly.

Alternatively or additionally, elements which arc included in a parent element, have a code that begins with the code of the parent clement and is followed by addition letters and/or digits which designate the specific element.

Alternatively to assigning the codes as described above, the MRD codes are assigned based on existing code systems from various fields of aircraft design, such as the wire codes defined in the above mentioned MIL-W-5088L standard. Optionally, two letters are added before these standard codes to designate the system and/or discipline to which they belong, in order to prevent two codes from different disciplines from assigning identical values.

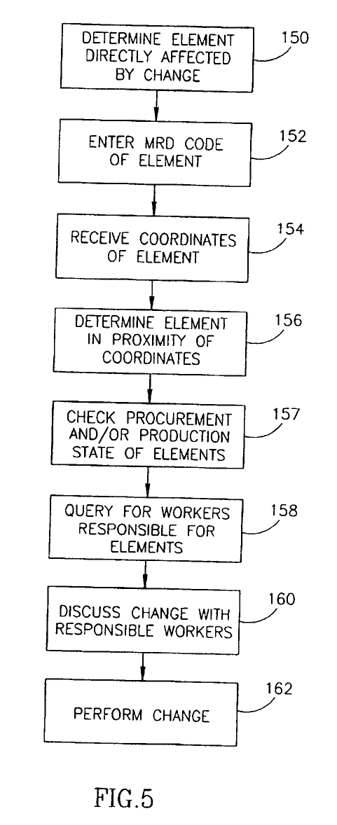

FIG. 5 is a flow chart of the actions performed by an engineer desiring to perform a change in the design of an aircraft, in accordance with an embodiment of the present invention. Changes may be performed for various reasons, such as problems detected by stress engineers, production personnel or other workers, failure of certain elements in ground or flight tests, and/or improvement attempts.

Optionally, before performing a change in the design of the aircraft, the engineer queries database 20 to determine (150) which major element is directly affected by the change. The change may include, for example, adding and/or removing one or more elements or changing an element's structure. Optionally, the engineer enters (152) the MRD code of the element directly affected by the change, and receives (154) the coordinates of the element. If the engineer does not know the MRD code he may search for it based on a part number or a function of the element. Alternatively or additionally, the engineer may search for the element using exact or approximate coordinates of the location of the clement.

The engineer optionally determines (156) which elements will be affected by the change. Affected elements may include elements which are in the physical place, required for adding or changing the element for which the change is initiated. Other affected elements are, for example, elements which become, due to the change, within close proximity to a different element beyond safety requirements, elements whose connectors moved due to the change, and elements for which accessibility for maintenance changes. In an embodiment of the invention, an automatic routine determines for a given change which elements are affected by the change.

In some embodiments of the invention, the engineer checks (157) the state of procurement or production of the affected elements to determine whether a change is worthwhile. For each of the affected elements, the engineer queries (158) for the workers responsible for the element. The engineer calls (160) these workers and determines with them whether the change is possible. If agreement is reached about the change, the engineer asks the person allowed to change records in database 20 to perform (162) the required change.

Alternatively or additionally, the engineer adds an action entry describing the desired change to the action list of the elements affected by the change. In some embodiments of the invention, a routine running on database 20 calls the attention of all the workers involved with the element to the new action entry, for example, by sending an e-mail message to the workers or a banner message which pops up on their work screen. Alternatively or additionally, workers periodically check the action lists of elements with which they are involved. Each of the notified workers may add an action to the action list approving or disapproving the change. Thus, most of workers 30 may submit their comments about the change in writing and do not need to come in person to a meeting where the issue of the change is determined. Optionally, the time required to determine whether to perform the change is thus reduced significantly.

In some embodiments of the present invention, database 20 includes a feature which allows sending e-mail messages to all the workers related to a specific element. Optionally, in opening the e-mail message database 20 is opened, displaying information relating to the element to which the e-mail message pertains. Thus, the recipient of the e-mail may immediately brief himself on the matter.

In an embodiment of the invention, a chat tool is associated with database 20. Each element 20 or group of elements, is assigned a virtual chat room in which workers 30 can discuss issues relating to the element. In some embodiments of the invention, a worker who wants to discuss a specific element enters a chat room by actuating a control displayed with database 20. Responsive there to a message is sent to all the workers related to the element notifying them the identity of the worker waiting in the chat room. Optionally, the user entering the chat room may perform other tasks, including on database 20, while waiting for other workers to enter the chat room.

In an embodiment of the invention, database 20 has a plurality of predetermined forms and/or reports which may be viewed by workers 30. Optionally, a worker may switch from one form to another using hypertext links which connect between related forms and reports. Thus, any worker can easily jump around database 20 to determine information on the overall design of the aircraft.

In some embodiments of the invention, workers 30 may use the forms and/or reports generated by database 20, as well as additional customized forms and/or reports in preparing reports. Optionally, a worker may use copy and paste computer features in preparing the reports in word processing tools. Alternatively or additionally, reports prepared by a word processor or other computerized tools may have one or more fields which receive their values from specific fields in database 20. Thus, every time the report is viewed or printed these fields receive their updated values.

In some embodiments of the present invention, a software associated with database 20 shows schematically the location in the aircraft of one or more elements of interest to a worker 30, based on the coordinates of the elements which are stored in the database. Thus, workers may view schematically the position of one or more element in the aircraft without having database 20 carry large graphical figures and drawings.

In some embodiments of the invention, database 20 includes electronic route cards that describe the actions performed and/or to be performed at different stages of the project on specific elements. In some embodiments of the invention, database 20 includes, for example, procurement, production and/or maintenance route cards. Optionally, workers 30 may customize personal route cards which include information from database 20 according to their specific needs. Workers 30 may optionally view and/or print any of the route cards.

Using the method of FIG. 5, most of the design problems of the aircraft are resolved at a very early stage, instead of leaving these problems to a later stage when changes are costly. Database 20 gives workers 30 an insight to the overall design of the aircraft so that the workers can resolve most of the interaction problems in the design on their own without the need for a large number of integration engineers and managers. Thus, the time required to design an aircraft is substantially shortened.

In some embodiments of the invention, a maintenance engineer may query for all the elements which are accessed through a specific access door. The maintenance engineer may determine the functionality of each element, the mean maintenance time of each element and the location of each element, and accordingly determine whether the aircraft design is feasible for maintenance. If any problems in maintenance arise, the maintenance engineer can easily determine which engineers are responsible for the problematic elements and contact the engineers in charge of the element.

In some embodiments of the present invention, design engineers 34 enter general descriptions of the elements they design to database 20 before the drawings of the elements are prepared. Production 36 and/or procurement 38 personnel optionally use the information in database 20 to determine whether production and/or procurement of such elements is feasible under the cost constraints of the design project. Thus, most design errors are found before changing the design is very costly and time consuming.

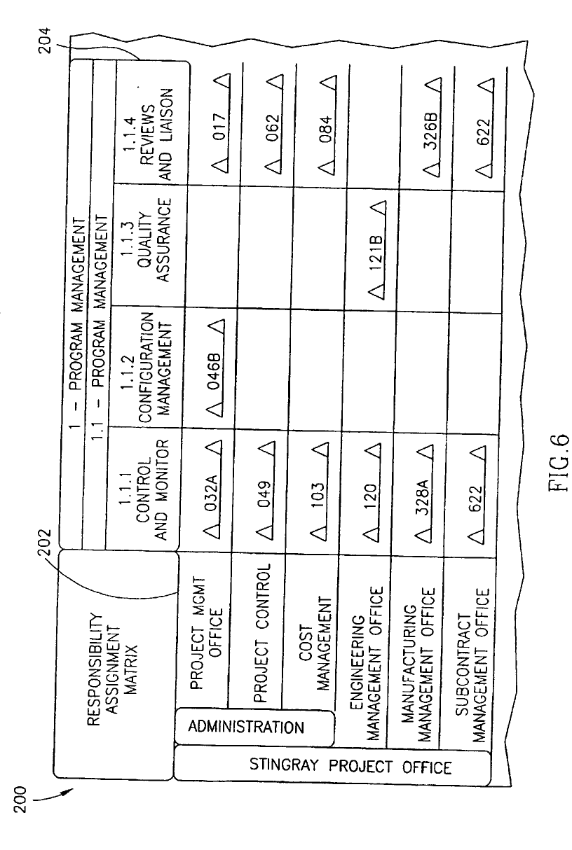

FIG. 6 is a schematic illustration of a responsibility assignment matrix (RAM) 200, in accordance with an embodiment of the present invention. Matrix 200 integrates an organization breakdown structure (OBS), shown on column 202, with a contract work breakdown structure (CWBS) shown on a heading row 204. Some of the intersection points are filled with engineer codes which represent the worker 30 in charge of the task described by the intersection point. Thus, RAM 200 is easily read by external entities who know nothing about the names of the workers in working environment 10. Furthermore, in case an engineer is replaced there is no need to update RAM 200. In some embodiments of the present invention, the engineer codes are used in order to identify workers also in other forms.

It is noted that although the above described embodiments relate to database 20 as a stand alone software, in some embodiments, the database is integrated with other software tools, such as PDM and/or CAD tools.

It is noted that the aerospace industry is highly conservative due to the stringent safety measures it requires, the complexity of its products, the large numbers of workers working on a single product and the planning time of the products. Thus, the present invention is highly relevant to this industry. It is noted, however, that although the above description is primarily related to design of the aerospace industry, some of the principles of the present invention are applicable to other industries, such as industries which produce other complex structures, such as other vehicles (e.g., automobiles, trains and ships), engines and complex constructions.

It will be appreciated that the above described methods may be varied in many ways, including, changing the exact implementation used. It should also be appreciated that the above described description of methods and apparatus are to be interpreted as including apparatus, especially computer systems, for carrying out the methods and methods of using the apparatus.

The present invention has been described using non-limiting detailed descriptions of embodiments thereof that are provided by way of example and are not intended to limit the scope of the invention. It should be understood that features described with respect to one embodiment may be used with other embodiments and that not all embodiments of the invention have all of the features shown in a particular figure. Variations of embodiments described will occur to persons of the art. Furthermore, the terms “comprise,” “include,” “have” and their conjugates, shall mean, when used in the claims, “including but not necessarily limited to.” The scope of the invention is limited only by the following claims:

1. A vehicle design database system, comprising:
a plurality of records which describe major elements of a vehicle, the records describing substantially only major elements;
at least one indication of the relative assembly of the major elements;
a plurality of references to workers in charge of the major elements; and
a plurality of references to documents related to the major elements.

2. A system according to claim 1, wherein the plurality of records comprise a record for each of the major elements of the vehicle, and the major elements comprise elements which interact with other elements of the vehicle.

3. A system according to claim 1 or claim 2, wherein the at least one indication of the relative assembly comprises an indication in each record of the major elements which are functionally related to the element described by the record.

4. A system according to any of the preceding claims, wherein the at least one indication of the relative assembly comprises an indication in each record of the coordinates in the vehicles framework of the element described by the record.

5. A system according to any of the preceding claims, wherein the at least one indication of the relative assembly comprises an indication for at least one of the major elements of an access door of the element.

6. A system according to any of the preceding claims, wherein the at least one indication of the relative assembly comprises an indication for at least one of the major elements of a compartment in which the element is located.

7. A system according to any of the preceding claims, wherein the at least one indication of the relative assembly comprises an indication in each record of the major elements with which the element interacts.

8. A system according to any of the preceding claims, wherein the database substantially does not comprise drawings.

9. A system according to any of the preceding claims, wherein the database requires less than 1 Gbytes of storage space.

10. A system according to claim 9, wherein the database requires less than 100 Mbytes of storage space.

11. A system according to any of the preceding claims, wherein the database includes records for less than 10% of the elements of the vehicle.

12. A system according to claim 11, wherein the database includes records for less than 1% of the elements of the vehicle.

13. A system according to any of the preceding claims, wherein the references to the documents comprise hypertext links.

14. A system according to any of the preceding claims, wherein the documents comprise diagrams including the elements.

15. A system according to any of the preceding claims, wherein the documents comprise procurement invoices of the elements.

16. A system according to any of the preceding claims, wherein each of the elements is identified by a unique code which is assigned according to a functionality of the element.

17. A system according to any of the preceding claims, wherein the database is associated with at least one computerized tool such that an update of information in the at least one computerized tool automatically updates the database.

18. A system according to any of the preceding claims, wherein the database is accessible over a network which connects a plurality of remote processors.

19. A system according to any of the preceding claims, wherein the database is stored on a portable computer.

20. A system according to any of the preceding claims, comprising input and output information of at least one data evaluation program molded into a form of the database.

21. A system according to claim 20, wherein the at least one data evaluation program comprises a design-to-cost program.

22. A system according to claim 20 or claim 21, wherein the at least one data evaluation program comprises a design-for-manufacture-and-assembly program.

23. A method of forming a vehicle design index, comprising:
automatically gathering, from a plurality of computerized tools, information on substantially all major elements of a vehicle; and
storing the information in the index.

24. A method according to claim 23, wherein gathering the information comprises gathering location information of the major elements.

25. A method according to claim 23 or claim 24, wherein gathering the information comprises gathering interconnection information of the major elements.

26. A method according to any of claims 23-25, wherein gathering the information comprises gathering references to documents describing the major elements.

27. A method according to any of claims 23-26, wherein a company designing the vehicle comprises at least one group of workers that arc restricted from viewing at least some information relating to the vehicle and wherein gathering the information comprises gathering information which is not restricted from viewing by substantially any of the workers of the company.

28. A method according to claim 27, wherein gathering the information comprises gathering from tools which carry information restricted from viewing by at least one group of workers within the company designing the vehicle.

29. A method according to any of claims 23-28, wherein storing the information comprises storing the information in a database.

30. A method according to any of claims 23-29, wherein gathering the information comprises gathering information on elements of an aircraft.

31. A method according to any of claims 23-30, wherein automatically gathering the information comprises automatically gathering the information periodically.

32. A method of providing information between workers designing a vehicle, comprising:
gathering, for each of a plurality of major elements of the vehicle, information regarding the element, including a plurality of different indications of the relative assembly of the element and a plurality of references to workers in charge of the element;
storing the gathered information in a database; and
searching the database for information on one or more of the major elements.

33. A method according to claim 32, wherein gathering the information comprises gathering references to documents related to the major elements.

34. A method according to claim 32 or claim 33, wherein the plurality of different indications of the relative assembly of the element comprise at least one indication of the location of the element.

35. A method according to claim 34, wherein the at least one indication of the location of the clement comprises an indication of the coordinates of the element within the vehicle.

36. A method according to claim 34 or 35, wherein the at least one indication of the location of the element comprises an indication of an access door to the element within the vehicle.

37. A method according to any of claims 34-36, wherein the at least one indication of the location of the element comprises an indication of a compartment in which the element is located.

38. A method according to any of claims 32-37, wherein the plurality of different indications of the relative assembly of the element comprise a list of the major elements with which the element is connected.

39. A method according to any of claims 32-38, wherein the plurality of different indications of the relative assembly of the element comprise an indication of a system to which the element belongs.

40. A method according to claim 39, wherein the indication of the system to which the element belongs comprises an indication of a relative function of the element within the system.

41. A method according to any of claims 32-40, comprising running a verification routine which finds design faults, on the database.

42. A method according to claim 41, wherein running the verification routine comprises running a routine which checks for elements which are distanced from each other less than a minimal allowed distance.

43. A method according to any of claims 32-42, wherein the database does not include diagrams or drawings.

44. An aircraft designed using the method of providing information of any of claims 32-43.

45. A method of labeling major elements of an aircraft, comprising:
determining for each major element a system to which the element belongs; and
assigning each of the major elements with a code which is unique to each occurrence of the element in the aircraft, responsive to the system to which the element belongs.

46. A method according to claim 45, wherein the major elements include elements belonging to the structure of the aircraft.

47. A method according to claim 45 or 46, wherein assigning the code comprises assigning a code having at least three digits in common with digits of a part number of the element, for substantially all the major elements of the aircraft.

48. A method according to any of claims 45-47, wherein assigning the code comprises assigning a plurality of codes to at least one single element.

49. A method according to claim 48, wherein the plurality of codes assigned to the at least one single element comprise codes which represent connection ends of the element.

50. A method of referencing workers working on an aircraft, comprising:
assigning configuration management codes to various aspects of the aircraft;
assigning each part of the aircraft, a part number code which includes the assigned configuration management code of the aspect to which the part belongs; and
assigning worker codes which include the configuration management code of the aspect on which the worker works.

51. A method according to claim 50, wherein the configuration management codes comprise three digits.

52. A method according to claim 50 or 51, comprising preparing a responsibility matrix which references workers by the assigned worker codes.
